(19) United States
(12) Patent Application Publication
(10) Pub. No.: US 2018/0112130 A1
(43) Pub. Date: Apr. 26, 2018

(54) SOIL STABILIZER

(71) Applicant: Jeff Wallace, Orange, CA (US)

(72) Inventor: Jeff Wallace, Orange, CA (US)

(21) Appl. No.: 15/299,362

(22) Filed: Oct. 20, 2016

(51) Int. Cl. C09K 17/22; C09K 17/52; C09K 17/32; E02D 3/12

(52) U.S. Cl. CPC C09K 17/22; E02D 3/12; C09K 17/32; C09K 17/52

(57) ABSTRACT

Compositions and methods for resisting soil erosion are shown. The compositions comprise either an aqueous mixture of a polymer mixed with an organic material or, alternatively, a polymer and organic material that can be mixed in water. The polymer preferably comprises polyacrylamide having anionic functional groups and the organic base comprises either cellulose, mulch and/or seed, and/or mulch. The methods of the present invention comprise providing or forming an aqueous mixture of the compositions of the present invention and applying them to an area of land sought to be provided with soil erosion resistance.

### FIELD

This invention relates to methods and compositions for reducing soil erosion, more specifically the compositions comprising a polymer component, a water component and an organic material component that act as a soil stabilizer upon application.

### BACKGROUND

Soil erosion, namely, the detachment of particles of soil and surficial sediments and rocks, is a serious problem recognized worldwide. Essentially, erosion occurs via the forces of wind and water that facilitate the movement of topsoil from one place to another. Of such forces, water erosion is generally considered more detrimental to soils both by the volume of soil removed, and the area of land influenced. Moreover, although soil erosion can potentially occur in any land surface, sloping areas mantled with soil or loose sediment are particularly susceptible to such forces. Indeed, current data seems to suggest that in the United States, soil has recently been eroded at about seventeen times the rate at which it forms. Further data suggests that soil erosion rates in Asia, Africa and South America are about twice as high as that in the United States.

Due to its significance, several attempts have been made to prevent or substantially reduce soil erosion. Among the more well-known of such methods include agricultural practices, such as contour farming and terracing, no-till cultivation, strip farming and polyvarietal cultivation. Other well-known approaches include adding organic material to soil which, by biochemical degradation, produces polysaccharides that are cohesive in nature and act to cause soil particles to stick together and resist erosion. Along these lines, products have been introduced to provide at least temporary erosion control, particularly with respect to slopes and the like until such time as trees and vegetation can take root to resist erosion. Such products include bonded fiber matrices, such as Soil Guard® produced by Mat Inc., of Floodwood, Minn., which comprises a continuous layer of elongated fiber strands held together by a water-resistant bonding agent. Such product is operative to eliminate direct raindrop impact on soil and further includes high water holding capacity that eventually biodegrades into plant nutrients.

Such products, however, are of limited effectiveness and often do not provide the degree of soil erosion resistance as is typically desired, particularly for use in relation to man-made slopes and terraces in arid regions, such as Southern California and Arizona. Such lack of effectiveness can and does often affect residential and commercial property development where man-made slopes are developed to support such structures and the like. In this regard, inadequate soil erosion resistance can culminate in the destruction of condemnation of buildings and dwellings, as well as create substantial storm water pollution. Moreover, such matrices can inhibit new plant growth by acting as a barrier against proper germination.

Accordingly, there is a substantial need in the art for a composition and method that is operative to resist soil erosion to a much greater degree than prior art compositions and methods. There is further need in the art for such compositions and methods that are non-toxic, biodegradable, can be readily deployed utilizing existing, commercially-available application techniques, and acts to serve as a soil conditioner. Still further, there is a need in the art for such a composition and method that is of simple formulation, relatively inexpensive to produce, and utilizes known, commercially-available materials.

### BRIEF SUMMARY OF THE INVENTION

The present invention specifically addresses and alleviates the above-identified deficiencies in the art. In this regard, the present invention is directed to compositions and methods for eliminating or substantially reducing soil erosion. According to the preferred embodiment, the composition comprises either an aqueous mixture of an organic material, which may comprise cellulose, mulch or a combination seed and mulch, and a hydrophilic polymer, the latter of which preferably comprises polyacrylamide or a mixture of polyacrylamide and sodium acrylate. Preferably, the polyacrylamide is provided with anionic functional groups. The soil erosion resisting composition may further be provided in the form of a reconstitutable powder or liquid concentrate comprised of the organic material mixed with polyacrylamide. In further refinements of the invention, the polymer component may comprise Earth Guard® soil-erosion resistant products produced by Terra Novo, Inc. of Bakersfield, Calif.

As to the methods of the present invention, the same essentially comprises providing an erosion-resistant composition of the aforementioned variety and applying the same to an area of land sought to be treated to consequently resist soil erosion. According to the preferred embodiment, the method comprises forming a first admixture of water and organic material, and thereafter adding the polymer to form a second admixture. The resultant admixture may be hydraulically applied, as per conventional soil erosion resistant compositions, such as bonded fiber matrix. Advantageously, the application of the compositions of the present invention are effective immediately upon application in resisting soil erosion and are non-toxic and biodegradable. Moreover, such methods can be practiced in any kind of weather and on any kind of soil, and are especially well-suited for use on slopes and the like. It is therefore an object of the present invention to provide compositions and methods for resisting soil erosion that can resist soil erosion to a far greater degree than prior art compositions and methods, particularly in relation to slopes and the like.

In an exemplary embodiment, a method for reducing soil erosion from an area of land comprising: providing a copolymer of linear polyacrylamide and sodium acrylate; providing an organic material selected from the group consisting of paper mulch, wood fiber mulch, or cellulose; mixing approximately 3000 gallons of water with the copolymer to form a first admixture, an amount of copolymer present in the first admixture being selected from a range of 8-10 gallons; and mixing the first admixture with the organic material to form a second admixture, an amount of organic material present in the second admixture being selected from a range of 2000-2500 pounds.

In another exemplary embodiment, comprising: applying the second admixture to the area of land, the area of land being approximately one acre of land and having a slope gradient ranging from 6:1 to 1:1. In another exemplary embodiment, comprising: applying the second admixture to the area of land, the area of land being approximately one acre of land and having a slope gradient ranging from 6:1 to 1:1.

In another exemplary embodiment, wherein the copolymer is present in an amount of 9 gallons and the organic material is present in an amount of 2000 pounds.

In another exemplary embodiment, wherein the organic material is selected from the group consisting of cellulose or mulch. In another exemplary embodiment, wherein said mulch is selected from the group consisting of paper mulch or wood fiber mulch.

In another exemplary embodiment, wherein the application of the second admixture is accomplished via a hydroseeder.

In an exemplary embodiment, a method for reducing soil erosion from an area of land comprising: providing a copolymer consisting of linear polyacrylamide polymer and sodium acrylate; providing an organic material selected from a group consisting of paper mulch, wood fiber mulch, or cellulose; mixing approximately 3000 gallons of water with the copolymer to form a first admixture; and mixing the first admixture with the organic material such that a second admixture is formed wherein: i) the copolymer is present in an amount within a range of 3-5 gallons, and ii) the organic material is present in an amount within a range of approximately 1000 pounds to one and one quarter tons.

In another exemplary embodiment, applying the second admixture to the area of land having a size ranging from one-half acre to one acre. In another exemplary embodiment, wherein the area of land has a slope gradient ranging from 6:1 to 1:1. In another exemplary embodiment, wherein the organic material weighs between 1000 pounds to 1200 pounds, and the slope gradient ranges from 5:1 to 4:1.

In an exemplary embodiment, a method for reducing soil erosion from an area of land comprising: providing a copolymer consisting of linear polyacrylamide and sodium acrylate; providing one or more organic materials selected from a group consisting of paper mulch, wood fiber mulch, or cellulose; and mixing water with the one or more organic materials and, subsequently with the copolymer such that an admixture is formed wherein: i) the copolymer is present in an amount within a range of 3-10 gallons, ii) the organic material is present in an amount within a range of 1500-2500 pounds, and ii) 3,000 gallons of water is present.

In another exemplary embodiment, applying the admixture to the area of land having a size of approximately one acre.

In another exemplary embodiment, wherein, the one or more organic materials weigh between 1,000 pounds and one ton.

In another exemplary embodiment, wherein the area of land has a slope gradient ranging from 5:1 to 1:5:1. In another exemplary embodiment, wherein the slope gradient ranges from 4:1 to 2:1.

In another exemplary embodiment, wherein the one or more organic materials weigh between 1200 pounds to one ton. In another exemplary embodiment, wherein the one or more organic materials weigh between 1200 pounds and 1500 pounds, and the slope gradient is approximately 3:1.

In another exemplary embodiment, wherein the one or more organic materials weigh between 1500 pounds and one ton, and the slope gradient ranges from 2:1 to 1.5:1.

Another object of the present invention is to provide a composition and method for resisting soil erosion that is non-toxic, biodegradable and safe for the environment.

Another object of the present invention is to provide a composition and method for resisting soil erosion that is of simple formulation, relatively inexpensive, and can be readily applied utilizing conventional application equipment and techniques.

Still further objects of the invention are to provide a composition and method for resisting soil erosion that is effective immediately upon application, can be applied in any type of weather, and can be utilized on virtually any type of soil.

### DETAILED DESCRIPTION OF THE INVENTION

The detailed description as set forth below is intended as a description of the presently preferred embodiments of the invention, and is not intended to represent the only form in which the present invention may be constructed or utilized. The description sets forth the functions and sequences of steps for constructing and operating the invention in connection with the illustrated embodiments. It is understood, however, that the same or equivalent functions and sequences may be accomplished by different embodiments and that they are also intended to be encompassed within the scope of this invention.

The present invention is directed to compositions and methods for preventing or substantially reducing soil erosion. With regard to the compositions, there is provided the combination of a polymer and an organic material that, in use, are mixed with water to form an aqueous admixture. In this respect, the compositions of the present invention may comprise either the polymer/organic material elements alone, which may be mixed with water, or, alternatively, an aqueous solution containing such components.

With respect to the former, the polymer element comprises polyacrylamide. Such polymer, which is well-known in the art, comprises CH₂:CHCONH₂ linear polymers polymeric through the vinyl groups. Preferably, the polyacrylamide is formulated such that the functional groups thereof are anionic and, hence, converted into polyelectrolytes. It should be understood, however, that cationic functional groups are contemplated as falling within the scope of the present invention. In a more highly refined embodiment, the polymer component comprises a copolymer mixture of acrylamide and sodium acrylate, present in a ratio of approximately 70:30, that is commercially available and sold under the trademark EarthGuard® by Terra Novo, Inc. of Bakersfield, Calif. As to the organic material, the same preferably comprises either cellulose, mulch and/or seed and mulch. With respect to the latter components, the same are well-known in the art. In this regard, such component may include materials such as recycled paper mulch and/or wood fiber mulch, among several other organic materials.

In one embodiment with respect to steep slopes, the basic aforementioned components that comprise the invention, by each component's specified unit, encompass the following:

TABLE 1

| Component | Value | Unit |
|---|---|---|
| Water | 3000 | gal. |
| Organic material | 2000-2500 | lb. |
| Polymer | 8-10 | gal. |

In one embodiment with respect to flat slopes, the basic aforementioned components that comprise the invention, by each component's specified unit, encompass the following:

TABLE 2

| Component | Value | Unit |
|---|---|---|
| Water | 3000 | gal. |
| Organic material | 1500 | lb. |
| Polymer | 3-5 | gal. |

Steep and flat slopes may be defined according to a slope gradient. For example, in one embodiment, a steep slope may be defined as having a slope gradient of 2:1 while a flat slope may be defined as having a slope gradient of 6:1. In other embodiments, other slope gradients may be define a steep slope and/or a flat slope. In yet other embodiments, a range of slope gradients may be used to define a steep slope and/or a flat slope. For example, a slope gradient range of 1.5:1-3.5:1 may define a steep slope while a slope gradient range of 3.6:1-6:1 may define a flat slope.

In a more highly refined embodiment, the invention may comprise 38% of anionic polyacrylamide and super absorbent polyacrylamide, and 62% of one or more inert ingredients. Further, in one embodiment, the polymer component may be comprised of 92% anionic polyacrylamide, and 8% super absorbent cross linked polyacrylamide.

For application, the polymer/organic composition will be mixed with water. To that end, it is contemplated that water may be added to the polymer/organic composition such that the following ratio is present: 3000 gallons of water, at least 1500 lbs. of organic material, and at least 3 gallons of polymer. Preferably, the water will be combined with the organic material, followed by the addition of the polymer. In one embodiment, the mixture may be distributed over one acre of land. Alternatively, if a higher amount of soil erosion protection is desired, the mixture may be distributed over one half of an acre of land. In yet another embodiment, the mixture may be consist of 3000 gallons of water, one ton to one and one quarter tons of organic material and eight to 10 gallons of polymer distributed over either one acre of land or one half of an acre of land.

With respect to application, the same may be applied by any of a variety of techniques known in the art. For example, the compositions of the present invention may be applied via hydroseeders, among others well-known in the art. As will be appreciated by those skilled in the art, in light of the compositions of the present invention including a high amount of polyacrylamide and/or polyacrylamide and sodium acrylate, the resultant admixture produced by adding the aqueous component with the polymer/organic material will consequently produce a gel or slurry that will require constant agitation, such as through the use of agitators and the like, or by thorough mixing at the time such ingredients are in contact with one another. With respect to the latter, it is currently contemplated that the polymer component, at a minimum, must be added directly to the still water how and thereafter the mixture is vigorously agitated for a minimum of five minutes prior to application of the resultant admixture.

Advantageously, the compositions of the present invention are non-toxic, biodegradable and can be applied to any types of soils in any type of weather conditions. Moreover, by simply using well-known and commercially available materials, in particular the polymer component of the present invention, the compositions and methods of using the same according to the present invention are substantially more cost effective than prior art compositions and methods.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

1. A method for reducing soil erosion from an area of land comprising:
providing a copolymer of linear polyacrylamide comprising anionic polyacrylamide ranging between 38-92% and sodium acrylate;
providing an organic material selected from the group consisting of paper mulch, wood fiber mulch, or cellulose;
mixing approximately 3000 gallons of water with the copolymer to form a first admixture, an amount of copolymer present in the first admixture being selected from a range of 8-10 gallons; and
mixing the first admixture with the organic material to form a second admixture, an amount of organic material present in the second admixture being selected from a range of 2000-2500 pounds.

2. The method of claim 1 further comprising:
applying the second admixture to the area of land, the area of land being approximately one acre of land and having a slope gradient ranging from 6:1 to 1:1.

3. The method of claim 1, wherein the copolymer is present in an amount of 9 gallons and the organic material is present in an amount of 2000 pounds.

4. The method of claim 1, wherein the organic material is selected from the group consisting of cellulose and paper mulch.

5. The method of claim 4, wherein said mulch is selected from the group consisting of cellulose and wood fiber mulch.

6. The method of claim 1, wherein the application of the second admixture is accomplished via a hydroseeder.

7. A method for reducing soil erosion from an area of land comprising:
providing a copolymer consisting of linear polyacrylamide polymer comprising anionic polyacrylamide ranging between 38-92% and sodium acrylate;
providing an organic material selected from a group consisting of paper mulch, wood fiber mulch, and cellulose;
mixing approximately 3000 gallons of water with the copolymer to form a first admixture; and
mixing the first admixture with the organic material such that a second admixture is formed wherein:
i) the copolymer is present in an amount within a range of 3-5 gallons, and
ii) the organic material is present in an amount within a range of approximately 1000 pounds to 2500 pounds.

8. The method of claim 7 further comprising:
applying the second admixture to the area of land having a size ranging from one-half acre to one acre.

9. The method of claim 8, wherein the area of land has a slope gradient ranging from 6:1 to 1:1.

10. The method of claim 9, wherein the organic material weighs between 1000 pounds to 1200 pounds, and the slope gradient ranges from 5:1 to 4:1.

11. A method for reducing soil erosion from an area of land comprising:
providing a copolymer consisting of linear polyacrylamide comprising anionic polyacrylamide ranging between 38-92% and sodium acrylate;
providing one or more organic materials selected from a group consisting of paper mulch, wood fiber mulch, and cellulose; and
mixing water with the one or more organic materials and, subsequently with the copolymer such that an admixture is formed wherein:
i) the copolymer is present in an amount within a range of 3-10 gallons,
ii) the one or more organic materials is present in an amount within a range of 1500-2500 pounds, and
ii) 3,000 gallons of water is present.

12. The method of claim 11 further comprising:
applying the admixture to the area of land having a size of approximately one acre.

13. The method of claim 11 wherein the organic materials weigh between 1500-2000 pounds.

14. The method of claim 13 wherein the area of land has a slope gradient ranging from 5:1 to 1.5:1.

15. The method of claim 14 wherein the slope gradient ranges from 4:1 to 2:1.

16. (canceled)

17. The method of claim 16 wherein the one or more organic materials weigh 1500 pounds, and the slope gradient is approximately 3:1.

18. The method of claim 14 wherein the organic materials weigh between 1500 pounds and 2000 pounds, and the slope gradient ranges from 2:1 to 1.5:1.
